(19) United States
(12) Patent Application Publication
(10) Pub. No.: US 2014/0063534 A1
(43) Pub. Date: Mar. 6, 2014

(54) PRINTING SYSTEM FOR IMPROVING RELIABILITY OF TEMPORARY AUTHENTICATION IN IMAGE FORMING APPARATUS, AND AUTHENTICATION METHOD

(71) Applicant: Kyocera Document Solutions Inc., Osaka (JP)

(72) Inventor: Takanao Kawai, Osaka (JP)

(73) Assignee: Kyocera Document Solutions Inc., Osaka (JP)

(21) Appl. No.: 13/974,670

(22) Filed: Aug. 23, 2013

(30) Foreign Application Priority Data
Aug. 29, 2012 (JP) 2012-189256

(51) Int. Cl. G06K 15/00

(52) U.S. Cl. CPC G06K 15/4095
USPC 358/1.14

(57) ABSTRACT

A printing system includes an image forming apparatus and a management server that are connected to the network each other. The image forming apparatus 1) transmits the accepted first authentication information to the management server, 2) stores the first authentication information in a storage unit if a result of authentication performed by the management server is success, and 3) authenticates the user based on second authentication information of the user that is newly accepted and the first authentication information stored in the storage unit if the authentication result is not transmitted from the management server. The management server performs the authentication based on the first authentication information transmitted from the image forming apparatus.

### INCORPORATION BY REFERENCE

This application is based upon, and claims the benefit of priority from, corresponding Japanese Patent Application No. 2012-189256, filed in the Japan Patent Office on Aug. 29, 2012, the entire contents of which are incorporated herein by reference.

### FIELD

Unless otherwise indicated herein, the description in this background section is not prior art to the claims in this application and is not admitted to be prior art by inclusion in this section. The present disclosure relates to printing systems including an image forming apparatus and a management server which manages users of the image forming apparatus, and authentication methods used by the printing systems.

### BACKGROUND

In typical printing systems, when communication between an image forming apparatus and a management server, which performs authentication based on the authentication information transmitted from the image forming apparatus, fails due to, for example, the management server shutting down or a network failure, the image forming apparatus performs temporary authentication. A user who is successfully authenticated via the temporary authentication can use the image forming apparatus under the condition that available functions are limited. In addition, a user who has been repeatedly temporarily authenticated by using different pieces of temporary authentication information can use the image forming apparatus in a state in which available functions are enhanced depending on the increase in the number of successful temporary authentications.

However, in typical printing systems, authentication performed by the management server is not associated with temporary authentication performed by the image forming apparatus. Therefore, it is not desirable from a security perspective that a user who has not been authenticated by the management server is successfully temporarily authenticated by the image forming apparatus and can use the image forming apparatus.

### SUMMARY

The present disclosure relates to printing systems for improving the reliability of temporary authentication in an image forming apparatus which is performed when communication between the image forming apparatus and a management server fails, and authentication methods used by the printing systems.

A printing system according to an embodiment of the present disclosure includes: an image forming apparatus configured to be connected to a network; and a management server configured to be connected to the network and communicate with the image forming apparatus.

The image forming apparatus includes a storage unit, an authentication-information accepting unit configured to accept first authentication information of a user, and an apparatus-side authentication unit configured to 1) transmit the first authentication information to the management server, 2) store the first authentication information in the storage unit if a result of the authentication performed by the management server is success, and 3) authenticate the user based on the second authentication information of the user that is newly accepted via the authentication-information accepting unit and the first authentication information that is stored in the storage unit if the authentication result is not transmitted from the management server.

The management server includes a server-side authentication unit configured to perform the authentication based on the first authentication information transmitted from the image forming apparatus.

An authentication method according to an embodiment of the present disclosure is performed by a printing system including an image forming apparatus configured to be connected to a network and a management server configured to be connected to the network and communicate with the image forming apparatus.

The method includes, via the image forming apparatus, accepting first authentication information of a user, transmitting the first authentication information to the management server, storing the first authentication information if a result of the authentication performed by the management server is success, and authenticating the user based on the second authentication information of the user that is newly accepted via the authentication-information accepting unit and the first authentication information that is stored if the authentication result is not transmitted from the management server.

The method further includes, via the management server, performing the authentication based on the first authentication information transmitted from the image forming apparatus.

Additional features and advantages are described herein, and will be apparent from the following Detailed Description and the figures.

### BRIEF DESCRIPTION OF THE FIGURES

In the accompanying drawings:

FIG. 1 is a block diagram illustrating a configuration of a printing system according to an embodiment of the present disclosure.

FIG. 2 is a block diagram illustrating a configuration of a multifunction peripheral (MFP) in the printing system.

FIG. 3 is a tabular diagram illustrating an example of user information of the MFP.

FIG. 4 is a block diagram illustrating a configuration of a management server in the printing system.

FIG. 5 is a tabular diagram illustrating exemplary user information of the management server.

FIG. 6 is a flowchart illustrating an operation performed by the MFP when user authentication information is inputted.

FIG. 7 is a flowchart illustrating an operation performed by the management server when an authentication request is received.

FIG. 8 is a flowchart illustrating an operation performed by the management server when update information is received.

FIG. 9 is a flowchart illustrating an operation performed by the MFP when job execution information is inputted.

### DETAILED DESCRIPTION

The configuration of a printing system 10 according to the present embodiment will be described.

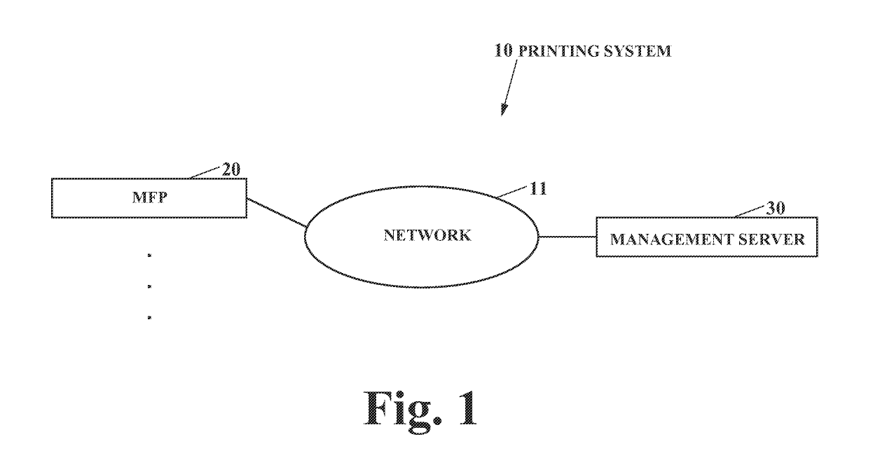

FIG. 1 is a block diagram illustrating a configuration of the printing system 10 according to the present embodiment.

The printing system 10 includes multiple multifunction peripherals (MFPs) including an MFP 20, and a management server 30 which manages users of the MFPs. The MFPs and the management server 30 are connected to each other in such a manner as to be capable of communicating with each other via a network 11, such as a local area network (LAN) or the Internet. Each of the MFPs constitutes an image forming apparatus in the present disclosure.

The configuration of each of the MFPs included in the printing system 10 is similar to that of the MFP 20. Therefore, the MFP 20 will be described below as a typical example of the MFPs included in the printing system 10.

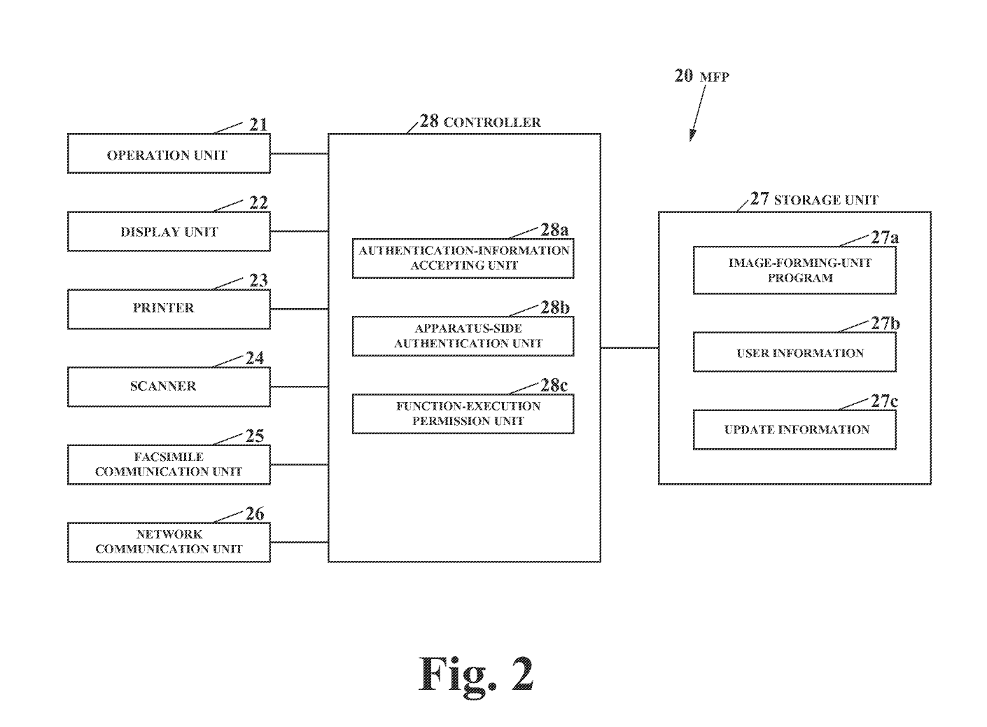

FIG. 2 is a block diagram illustrating a configuration of the MFP 20.

As illustrated in FIG. 2, the MFP 20 includes an operation unit 21 which comprises input devices such as buttons, by which various operations performed by a user are inputted, a display unit 22 which is a display device such as a liquid crystal display (LCD) which displays various types of information, a printer 23 which performs printing on paper, a scanner 24 which is a reading device which reads out an image from a document, a facsimile communication unit 25 which performs facsimile communication via a communication line such as a public telephone circuit with an external facsimile (not illustrated), a network communication unit 26 which communicates with an external apparatus via the network 11 (see FIG. 1), a storage unit 27 which is a nonvolatile storage device, such as an electrically erasable programmable read only memory (EEPROM) or a hard disk drive (HDD), which stores various data, and a controller 28 which controls the entire MFP 20.

The storage unit 27 stores an image-forming-unit program 27a which is a program for the MFP 20, and user information 27b which is information about users.

The image-forming-unit program 27a may be installed in the MFP 20 during manufacturing of the MFP 20, or may be installed in the MFP 20 from a storage medium, such as a Secure Digital (SD) memory card or a Universal Serial Bus (USB) memory. Further, the image-forming-unit program 27a may be additionally installed in the MFP 20 via the network 11.

The storage unit 27 can store update information 27c which updates permission information in user information 34b stored in a storage unit 34, which is described below, of the management server 30 (see FIG. 1). The update information 27c is information about executed jobs. For example, a piece of the update information 27c about a copy job in which an image which is read out from a document by using the scanner 24 is printed on paper by using the printer 23 contains the size of output paper, the number of copies, the total number of copying prints, information about whether color copying or monochrome copying is performed, and about whether duplex printing or simplex printing is performed.

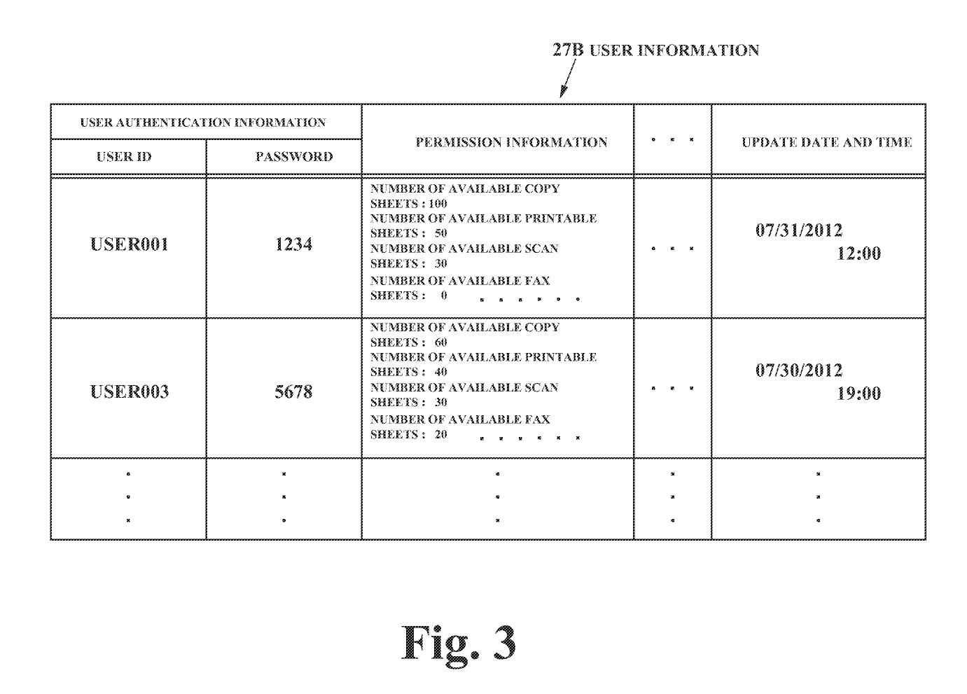

FIG. 3 is a tabular diagram illustrating an example of user information 27b.

As illustrated in FIG. 3, the user information 27b comprises information for each user which includes user authentication information, permission information indicating execution permissions for MFP functions, and an update date and time of the information.

The authentication information is information obtained by combining a user ID which is user identification information, with a password.

The permission information is, for example, information containing the number of available copy sheets, up to which a user can perform copying, the number of available printable sheets, up to which a user can print an image received via the network communication unit 26 on paper by using the printer 23, the number of available scan sheets, up to which a user can scan an image from a document using the scanner 24, and the number of available fax sheets, up to which a user can transmit a fax via the facsimile communication unit 25.

The number of available copy sheets, the number of available printable sheets, the number of available scan sheets, and the number of available fax sheets are information indicating permission values, up to which functions are executed, as function execution authorization, and comprise permission value information of the present disclosure.

In the user information 27b illustrated in FIG. 3, the password of a user whose user ID is “USER001” is “1234”. The number of available copy sheets, the number of available printable sheets, the number of available scan sheets, and the number of available fax sheets for the user whose user ID is “USER001” is “100”, “50”, “30”, and “0”, respectively. The update date and time of the information for the user whose user ID is “USER001” is “Jul. 31, 2012 at 12:00”.

The controller 28 illustrated in FIG. 2 includes a central processing unit (CPU), a read only memory (ROM) which stores programs and various data in advance, and a random access memory (RAM) used as a work area for the CPU. The CPU executes programs stored in the ROM or the storage unit 27.

The controller 28 executes the image-forming-unit program 27a stored in the storage unit 27, thereby serving as an authentication-information accepting unit 28a which accepts user authentication information, an apparatus-side authentication unit 28b which authenticates a user based on the authentication information accepted by the authentication-information accepting unit 28a, and a function-execution permission unit 28c which permits the user to perform the functions of the MFP 20.

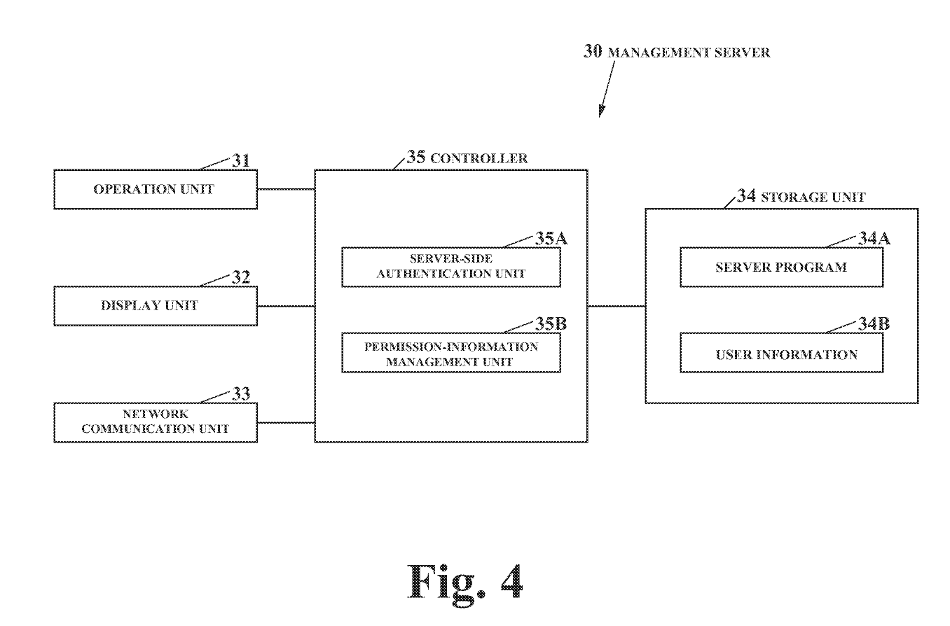

FIG. 4 is a block diagram illustrating a configuration of the management server 30.

As illustrated in FIG. 4, the management server 30 includes an operation unit 31 which comprises input devices, such as a mouse and a keyboard, through which various operations are inputted, a display unit 32 which is a device such as an LCD which displays various types of information, a network communication unit 33 which communicates with an external apparatus via the network 11 (see FIG. 1), a storage unit 34 which is a device such as an HDD which stores programs and various data, and a controller 35 which controls the entire management server 30. The management server 30 is comprised by a computer such as a personal computer (PC).

The storage unit 34 stores a server program 34a for the management server 30 and the user information 34b which is information about users.

The server program 34a may be installed in the management server 30 during manufacturing of the management server 30, or may be installed in the management server 30 from a storage medium, such as a compact disk (CD) or a digital versatile disk (DVD). Further, the server program 34a may be installed in the management server 30 via the network 11.

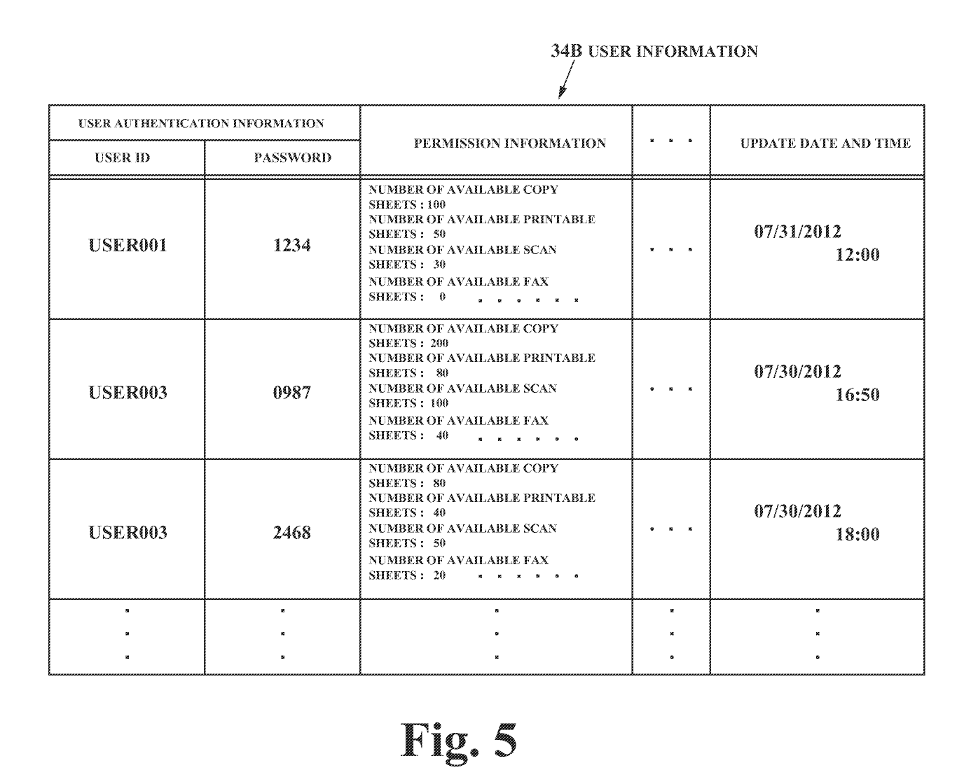

FIG. 5 is a tabular diagram illustrating an example of user information 34b.

In the user information 27b illustrated in FIG. 3, information about only users who have been successfully authenticated by the management server 30 based on the authentication requests transmitted from the MFP 20 is registered. Therefore, in the user information 34b illustrated in FIG. 5, user information which is not registered in the user information 27b illustrated in FIG. 3 may be registered. For example, in the user information 34b illustrated in FIG. 5, information about a user whose user ID is “USER002” is registered as a user who is not registered in the user information 27b illustrated in FIG. 3.

For example, when the MFP 20 does not successfully communicate with the management server 30, the user information 27b illustrated in FIG. 3 and the user information 34b illustrated in FIG. 5 may be separately updated. For example, the password, the permission information, and the update date and time for a user whose user ID is “USER003”, in the user information 27b illustrated in FIG. 3 are different from those in the user information 34b illustrated in FIG. 5.

The controller 35 illustrated in FIG. 4 includes a CPU, a ROM which stores programs and various data in advance, and a RAM that is used as a work area for the CPU. The CPU executes the programs stored in the ROM or the storage unit 34.

The controller 35 executes the server program 34a stored in the storage unit 34, thereby serving as a server-side authentication unit 35a which performs authentication based on the authentication information transmitted from an MFP, and a permission-information management unit 35b which manages permission information of users.

Operations of the printing system 10 will be described.

First, operations performed in the printing system 10 when a user logs in to the MFP 20 will be described.

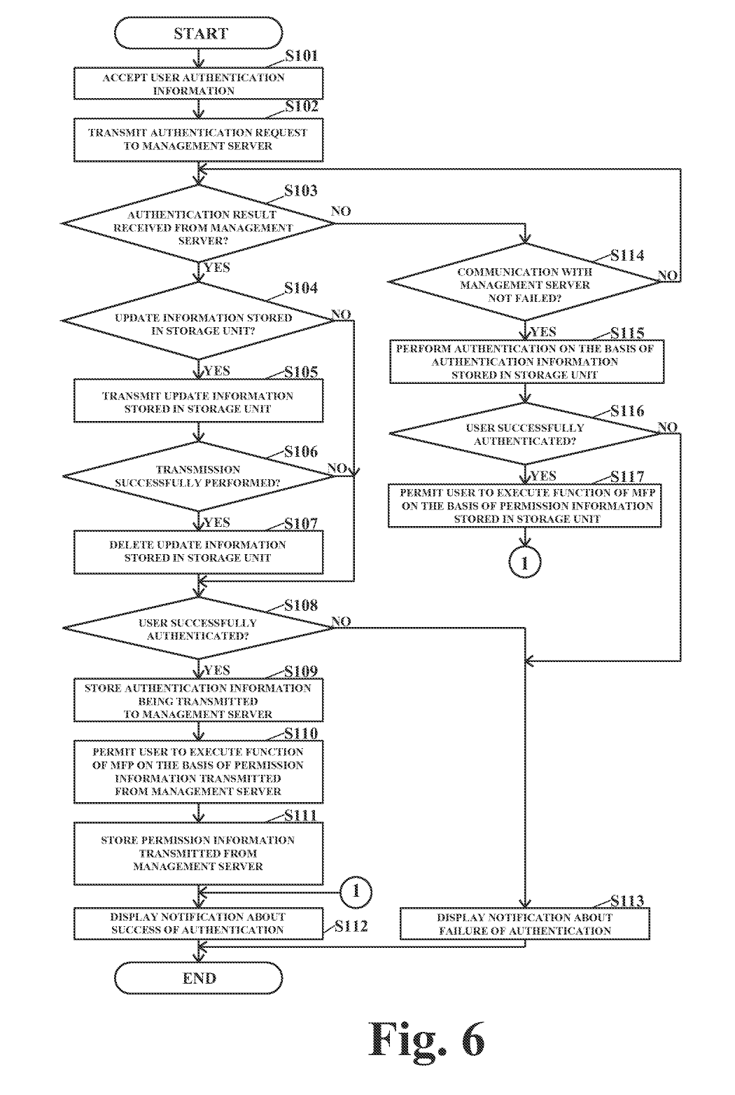

When a user inputs a combination of his/her user ID and the password, that is, authentication information, by using the operation unit 21 to log in to the MFP 20, or when the user inputs his/her authentication information from a PC or the like, which is an external apparatus, via the network 11 into the MFP 20 to log in to the MFP 20, the controller 28 of the MFP 20 performs the operations illustrated in FIG. 6.

FIG. 6 is a flowchart illustrating an operation performed by the MFP 20 when user authentication information is inputted.

As illustrated in FIG. 6, the authentication-information accepting unit 28a of the controller 28 of the MFP 20 accepts user authentication information via the operation unit 21 or the network communication unit 26 (in step S101).

Then, the apparatus-side authentication unit 28b of the controller 28 transmits an authentication request including the authentication information accepted in step S101 via the network communication unit 26 to the management server 30 (in step S102).

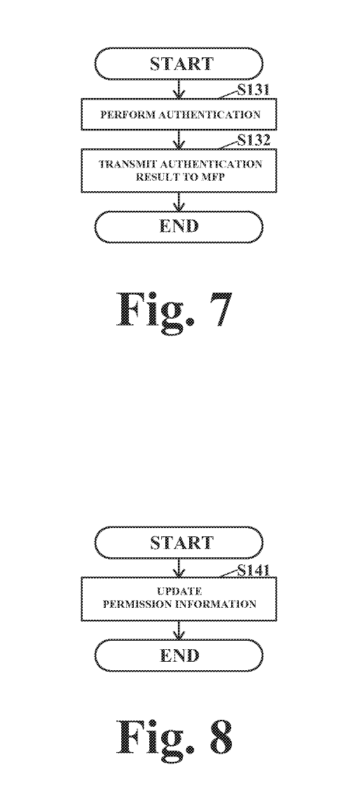

Receiving the authentication request via the network communication unit 33, the controller 35 of the management server 30 performs the operations illustrated in FIG. 7.

FIG. 7 is a flowchart illustrating an operation performed by the management server 30 when an authentication request is received.

As illustrated in FIG. 7, the server-side authentication unit 35a of the controller 35 of the management server 30 performs authentication based on the authentication request received from the MFP 20 via the network communication unit 33 (in step S131). If the authentication information is registered in the user information 34b on the storage unit 34 so as to be associated with the user, the server-side authentication unit 35a determines that the result of the authentication of the user is success. For example, in the case where the user ID and the password in the authentication information included in the authentication request are “USER001” and “1234”, respectively, and where the user information 34b on the storage unit 34 is the same as the information illustrated in FIG. 5, the authentication information is registered in the user information 34b on the storage unit 34 in such a manner as to be associated with the user whose user ID is “USER001”. Therefore, the server-side authentication unit 35a determines that the result of the authentication of the user is success. If the authentication information is not registered in the user information 34b so as to be associated with the user, the server-side authentication unit 35a determines that the result of the authentication of the user is failure.

Then, the server-side authentication unit 35a transmits an authentication result which is the result of the authentication performed in step S131, via the network communication unit 33 to the MFP 20 (in step S132). If the result of the authentication performed in step S131 is success, the server-side authentication unit 35a sets, to the authentication result, a message that the user is successfully authenticated, and the permission information registered in the user information 34b on the storage unit 34 so that the permission information is associated with the user. For example, when the user whose user ID is “USER001” is successfully authenticated in step S131, the server-side authentication unit 35a sets, to the authentication result, a message that the user whose user ID is “USER001” is successfully authenticated in step S131, and the permissions registered in the user information 34b on the storage unit 34 so that the permissions are associated with the user, for example, the permissions of “the number of available copy sheets which is equal to 100”, “the number of available printable sheets which is equal to 50”, “the number of available scan sheets which is equal to 30”, and “the number of available fax sheets which is equal to 0”. If the result of the authentication performed in step S131 is failure, the server-side authentication unit 35a sets, to the authentication result, a message that the result of the authentication of the user is failure.

When the process in step S132 ends, the controller 35 of the management server 30 ends the operations illustrated in FIG. 7.

As illustrated in FIG. 6, after the process in step S102, the apparatus-side authentication unit 28b of the controller 28 of the MFP 20 determines whether or not the authentication result has been received from the management server 30 via the network communication unit 26 (in step S103).

If the apparatus-side authentication unit 28b determines that the authentication result has been received from the management server 30 via the network communication unit 26 in step S 103, the function-execution permission unit 28c of the controller 28 determines whether or not the update information 27c is stored in the storage unit 27 (in step S104).

If the function-execution permission unit 28c determines that the update information 27c is stored in the storage unit 27 in step S104, the function-execution permission unit 28c transmits all the pieces of the update information 27c stored in the storage unit 27 via the network communication unit 26 to the management server 30 (in step S105). The update information 27c to be transmitted to the management server 30 in step S105 is not limited to a piece of the update information 27c about a user who is operating the MFP 20, and is all the pieces of the update information 27c stored in the storage unit 27.

Receiving the update information 27c via the network communication unit 33, the controller 35 of the management server 30 performs the operation illustrated in FIG. 8.

FIG. 8 is a flowchart illustrating the operation performed by the management server 30 when the update information 27c is received.

As illustrated in FIG. 8, the permission-information management unit 35b of the controller 35 of the management server 30 updates the permission information stored in the user information 34b on the storage unit 34 based on the update information 27c received from the MFP 20 via the network communication unit 33 (in step S141). For example, in the case where the permission-information management unit 35b receives the update information 27c indicating that the user whose user ID is “USER001” executed a job of “printing an image received via the network communication unit 26 on N sheets by using the printer 23”, the permission-information management unit 35b subtracts N from the number of available printable sheets which is stored in the user information 34b on the storage unit 34 for the user whose user ID is “USER001”.

When the process in step S141 ends, the controller 35 of the management server 30 ends the operation illustrated in FIG. 8.

As illustrated in FIG. 6, after the process in step S105, the function-execution permission unit 28c of the controller 28 of the MFP 20 determines whether or not the transmission is successfully performed in step S105 (in step S106).

If the function-execution permission unit 28c determines that the transmission is successfully performed in step S106, the function-execution permission unit 28c deletes all the pieces of the update information 27c stored in the storage unit 27 (in step S107).

The apparatus-side authentication unit 28b of the controller 28 determines whether or not the management server 30 has successfully authenticated the user, based on the authentication result received from the management server 30 (in step S108), when either of the following conditions is satisfied: that it is determined that the update information 27c is not stored in the storage unit 27 in step S104; that it is determined that the transmission has failed in step S106; and that the process in step S107 ends.

If the apparatus-side authentication unit 28b determines that the management server 30 has successfully authenticated the user in step S108, the apparatus-side authentication unit 28b stores the authentication information which was transmitted to the management server 30 in step S102 in the user information 27b on the storage unit 27 (in step S109). If another piece of authentication information of the user for whom the received authentication information is to be written in the user information 27b is already stored in the user information 27b, the apparatus-side authentication unit 28b overwrites the authentication information already stored in the user information 27b with the new authentication information.

The function-execution permission unit 28c of the controller 28 permits the user to execute the functions of the MFP 20 based on the permission information transmitted from the management server 30 as part of the authentication result (in step S110).

The function-execution permission unit 28c stores the permission information transmitted from the management server 30 as part of the authentication result, in the user information 27b on the storage unit 27 (in step S111). If another piece of permission information of the user for whom the received permission information is to be written in the user information 27b is already stored in the user information 27b, the function-execution permission unit 28c overwrites the permission information already stored in the user information 27b with the new permission information.

The apparatus-side authentication unit 28b of the controller 28 displays a notification about the success of the authentication on the display unit 22 (in step S112), and ends the operations illustrated in FIG. 6.

If the apparatus-side authentication unit 28b determines that the management server 30 has failed to authenticate the user in step S108, the apparatus-side authentication unit 28b displays a notification about the failure of the authentication on the display unit 22 (in step S113), and ends the operations illustrated in FIG. 6.

If the apparatus-side authentication unit 28b determines that the authentication result has not been received from the management server 30 via the network communication unit 26 in step S103, the apparatus-side authentication unit 28b determines whether or not the communication with the management server 30 has failed (in step S114).

If the apparatus-side authentication unit 28b determines that communication with the management server 30 has not failed in step S114, the apparatus-side authentication unit 28b performs the process in step S103 again.

If the apparatus-side authentication unit 28b determines that communication with the management server 30 has failed in step S114, the apparatus-side authentication unit 28b performs authentication based on the authentication information accepted in step S101 and the authentication information stored in the user information 27b on the storage unit 27 (in step S115). If the authentication information accepted in step S101 is registered in the user information 27b on the storage unit 27 so as to be associated with the user, the apparatus-side authentication unit 28b determines that the result of the authentication of the user is success. For example, in the case where the user ID and the password in the authentication information accepted in step S101 are “USER001” and “1234”, respectively, and where the user information 27b on the storage unit 27 is equal to the information illustrated in FIG. 3, the authentication information accepted in step S101 is registered in the user information 27b on the storage unit 27 so as to be associated with the user whose user ID is “USER001”. Therefore, the apparatus-side authentication unit 28b determines that the result of the authentication of the user is success. If the authentication information accepted in step S101 is not registered in the user information 27b so as to be associated with the user, the apparatus-side authentication unit 28b determines that the result of the authentication of the user is failure.

The apparatus-side authentication unit 28b determines whether or not the result of the authentication of the user in step S115 is success (in step S116).

If the apparatus-side authentication unit 28b determines that the result of the authentication of the user is success in step S116, the function-execution permission unit 28c of the controller 28 permits the user to execute the functions of the MFP 20 based on the permission information stored in the user information 27b on the storage unit 27 (in step S117).

The apparatus-side authentication unit 28b of the controller 28 displays a notification about the success of the authentication on the display unit 22 (in step S112), and ends the operations illustrated in FIG. 6.

If the apparatus-side authentication unit 28b determines that the result of the authentication of the user is failure in step S116, the apparatus-side authentication unit 28b displays a notification about the failure of the authentication on the display unit 22 (in step S113), and ends the operations illustrated in FIG. 6.

The operations performed in the printing system 10 when the user executes a function of the MFP 20 will be described.

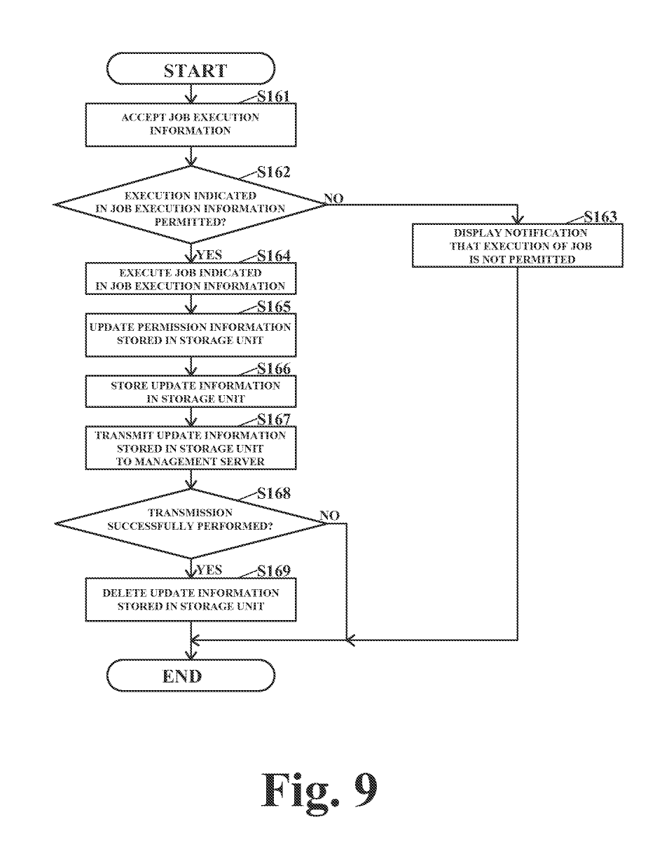

When the user inputs job execution information, which is an instruction to execute a function of the MFP 20, from the operation unit 21, or when the user inputs the job execution information from a PC or the like which is an external apparatus via the network 11 into the MFP 20, the controller 28 of the MFP 20 executes the operations illustrated in FIG. 9.

FIG. 9 is a flowchart illustrating the operation performed by the MFP 20 when job execution information is inputted.

As illustrated in FIG. 9, the function-execution permission unit 28c of the controller 28 of the MFP 20 accepts the job execution information which is inputted via the operation unit 21 or the network communication unit 26 (in step S 161).

The function-execution permission unit 28c determines whether or not execution indicated in the job execution information accepted in step S161 is permitted (in step S162). For example, in the case where the execution indicated in the job execution information is to “print an image received via the network communication unit 26 on N sheets by using the printer 23”, if the number of available printable sheets which is stored in the user information 27b on the storage unit 27 for the user who has inputted the job execution information is equal to or more than N, the function-execution permission unit 28c determines that the execution indicated in the job execution information is permitted. In the case where the execution indicated in the job execution information is to “print an image received via the network communication unit 26 on N sheets by using the printer 23”, if the number of available printable sheets which is stored in the user information 27b on the storage unit 27 for the user who has inputted the job execution information is less than N, the function-execution permission unit 28c determines that the execution indicated in the job execution information is not permitted.

If the function-execution permission unit 28c determines that the execution indicated in the job execution information is not permitted in step S162, the function-execution permission unit 28c displays a notification that execution of the job is not permitted, on the display unit 22 (in step S163), and ends the operations illustrated in FIG. 9.

If the function-execution permission unit 28c determines that the execution indicated in the job execution information is permitted in step S162, the function-execution permission unit 28c executes the job indicated in the job execution information accepted in step S161 (in step S164).

The function-execution permission unit 28c updates the permission information stored in the user information 27b on the storage unit 27 based on the operation of the job executed in step S164 (in step S165). For example, when the job of “printing an image received via the network communication unit 26 on N sheets by using the printer 23” is executed, the function-execution permission unit 28c subtracts N from the number of available printable sheets which is stored in the user information 27b on the storage unit 27.

The function-execution permission unit 28c stores the update information 27c based on the operation of the job executed in step S164 in the storage unit 27 (in step S166).

The function-execution permission unit 28c transmits all the pieces of the update information 27c stored in the storage unit 27 via the network communication unit 26 to the management server 30 (in step S167). The update information 27c transmitted to the management server 30 in step S167 is not limited to a piece of the update information 27c for the user who is logging in to the MFP 20, and is all the pieces of the update information 27c stored in the storage unit 27.

Receiving the update information 27c via the network communication unit 33, the controller 35 of the management server 30 performs the operations illustrated in FIG. 8. That is, the permission-information management unit 35b of the controller 35 of the management server 30 updates the permission information stored in the user information 34b on the storage unit 34 based on the update information 27c received from the MFP 20 via the network communication unit 33.

As illustrated in FIG. 9, the function-execution permission unit 28c of the controller 28 of the MFP 20 determines whether or not the transmission was successfully performed in step S167 (in step S168).

If the function-execution permission unit 28c determines that the transmission is successfully performed in step S168, the function-execution permission unit 28c deletes all the pieces of the update information 27c stored in the storage unit 27 (in step S169), and ends the operations illustrated in FIG. 9.

If the function-execution permission unit 28c determines that the transmission has failed in step S168, the function-execution permission unit 28c does not perform the process in step S169, and ends the operations illustrated in FIG. 9.

As described above, in the printing system 10, when the result of the authentication performed by the management server 30 is success (YES in step S108), the authentication information which was transmitted by the MFP 20 to the management server 30 is stored in the storage unit 27 (in step S109). When an authentication result is not transmitted from the management server 30 to the MFP 20 (YES in step S114), the MFP 20 performs authentication based on the authentication information stored in the storage unit 27 (in step S115). Therefore, the state in which the authentication performed by the management server 30 matches that by the MFP 20 can be maintained. Consequently, the printing system 10 achieves improved reliability of the authentication in the MFP 20 which is performed when the communication between the MFP 20 and the management server 30 fails.

In the printing system 10, when the permission information is transmitted from the management server 30 (YES in step S108), the permission information is stored in the storage unit 27 (in step S111). When the permission information is not transmitted from the management server 30 (YES in step S114), the user is permitted to execute the functions of the MFP 20 based on the permission information stored in the storage unit 27 (in step S117). Therefore, the state in which permission for the user to execute the functions of the MFP 20 which is given by the management server 30 matches that which is given by the MFP 20 can be maintained.

In the printing system 10, when the MFP 20 performs a function (in step S164), the MFP 20 transmits execution amount information which indicates the amount by which the function has been performed, as the update information 27c to the management server 30 (in step S167). Therefore, for the authorization in which permission values are changed depending on the execution of the functions, that is, for the permission value information, such as the number of available copy sheets, the number of available printable sheets, the number of available scan sheets, and the number of available fax sheets, the state in which the permission condition which is set by the management server 30 matches that which is set by the MFP 20 can be maintained.

In the printing system 10, in the case where the transmission of the update information 27c to the management server 30 has failed (NO in step S106, or NO in step S168), when the MFP 20 successfully communicates with the management server 30, the update information 27c is transmitted to the management server 30 (in step S105 or in step S167). Therefore, for the authorization in which permission values are changed depending on execution of the functions, that is, for the permission value information, the long-period state in which the permission condition which is set by the management server 30 is different from that by the MFP 20 can be suppressed.

In an embodiment, the MFP 20 tries to transmit the update information 27c accumulated on the storage unit 27 to the management server 30 every time the MFP 20 receives an authentication result from the management server 30. Alternatively, the try may be performed at another time. For example, the MFP 20 may try to transmit the update information 27c accumulated on the storage unit 27 to the management server 30 at predetermined intervals of, for example, a few seconds or a few minutes.

In the printing system 10, if the storage unit 27 is a volatile storage device, power-down of the MFP 20 causes the permission information stored in the storage unit 27 to be removed, whereby functions may be performed without authorization. However, in the printing system 10, the storage unit 27 is a nonvolatile storage device. In the case where a user is permitted to execute the functions of the MFP 20 based on the permission information stored in the storage unit 27, unauthorized execution caused by power-down of the MFP 20 may be suppressed.

While various aspects and embodiments have been disclosed herein, other aspects and embodiments are possible. Other designs may be used in which the above-described components are each present.

In the printing system 10, in an embodiment, the authentication information is information obtained by combining a user ID and a password. Other information may be used as the authentication information. For example, in the printing system 10, data of an ID card (for example, a card ID) of a user which is read by using an ID card reader provided for the MFP 20 may be used as the authentication information. Alternatively, fingerprint data of a user which is read by using a fingerprint sensor provided for the MFP 20 may be used as the authentication information.

In an embodiment, the examples of the permission value information of the present disclosure are the number of available copy sheets, the number of available printable sheets, the number of available scan sheets, and the number of available fax sheets. Other information may be used as the permission value information. For example, the permission value information of the present disclosure may contain limits on fax transmission time which indicates an amount of time in which fax transmission can be performed via the facsimile communication unit 25.

The permission-information management unit 35b of the management server 30 may not only manage the permission information of users, but also manage charges on users based on the permission information.

In an embodiment, the printing system 10 includes an MFP as an image forming apparatus of the present disclosure. The printing system 10 may include an image forming apparatus other than an MFP, such as a printer-dedicated apparatus, a copy-dedicated apparatus, or a facsimile-dedicated apparatus.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A printing system comprising:
an image forming apparatus configured to be connected to a network; and
a management server configured to be connected to the network and communicate with the image forming apparatus,
the image forming apparatus includes
a storage unit,
an authentication-information accepting unit configured to accept first authentication information of a user, and
an apparatus-side authentication unit configured to 1) transmit the first authentication information to the management server, 2) store the first authentication information in the storage unit if a result of authentication performed by the management server is success, and 3) authenticate the user based on second authentication information of the user that is newly accepted via the authentication-information accepting unit and the first authentication information that is stored in the storage unit if the authentication result is not transmitted from the management server, and
the management server includes
a server-side authentication unit configured to perform the authentication based on the first authentication information transmitted from the image forming apparatus.

2. The printing system according to claim 1,
wherein the image forming apparatus includes a function-execution permission unit configured to permit the user to execute a function of the image forming apparatus,
the function-execution permission unit is configured to 1) if permission information indicating authorization for the user to execute a function of the image forming apparatus is transmitted from the management server, permit the user to execute the function of the image forming apparatus based on the permission information, and store the permission information in the storage unit, and 2) if the permission information is not transmitted from the management server, permit the user to execute the function of the image forming apparatus based on the permission information that is stored in the storage unit, and
if the result of the authentication of the user is success, the server-side authentication unit is configured to transmit the permission information to the image forming apparatus.

3. The printing system according to claim 1,
wherein the permission information includes permission value information indicating a permission value for execution of the function as the authorization to execute the function, and
if the function is performed, the function-execution permission unit is configured to transmit execution amount information indicating an amount by which the function has been performed, to the management server.

4. The printing system according to claim 3,
wherein, when transmission of the execution amount information to the management server has failed, if the image forming apparatus successfully communicates with the management server, the function-execution permission unit is configured to transmit the execution amount information to the management server.

5. The printing system according to claim 1,
wherein the storage unit includes a nonvolatile storage device.

6. An authentication method by a printing system including an image forming apparatus configured to be connected to a network and a management server configured to be connected to the network and communicate with the image forming apparatus, the method comprising:
via the image forming apparatus,
accepting first authentication information of a user,
transmitting the first authentication information to the management server,
storing the first authentication information if a result of authentication performed by the management server is success, and
authenticating the user based on second authentication information of the user that is newly accepted via the authentication-information accepting unit and the first authentication information that is stored if the authentication result is not transmitted from the management server, and
via the management server,
performing the authentication based on the first authentication information transmitted from the image forming apparatus.

7. The authentication method according to claim 6, comprising:
via the image forming apparatus,
permitting, if permission information indicating authorization for the user to execute a function of the image forming apparatus is transmitted from the management server, the user to execute the function of the image forming apparatus based on the permission information, storing the permission information, and
permitting, if the permission information is not transmitted from the management server, the user to execute the function of the image forming apparatus based on the permission information that is stored, and
via the management server,
transmitting, if the result of the authentication of the user is success, the permission information to the image forming apparatus.

8. The authentication method according to claim 6,
wherein the permission information includes permission value information indicating a permission value for execution of the function as the authorization to execute the function, and
if the function is performed, execution amount information indicating an amount by which the function has been performed is transmitted to the management server via the image forming apparatus.

9. The authentication method according to claim 8,
wherein, when transmission of the execution amount information to the management server has failed, if the image forming apparatus successfully communicates with the management server, the execution amount information is transmitted to the management server via the image forming apparatus.

10. The authentication method according to claim 6,
wherein the authentication information is stored in a nonvolatile storage device.

11. The authentication method according to claim 7,
wherein the permission information is stored in a nonvolatile storage device.
